(19) United States
(12) Patent Application Publication
(10) Pub. No.: US 2018/0231367 A1
(43) Pub. Date: Aug. 16, 2018

(54) ALIGNMENT AID

(71) Applicant: Allen Daniel Stephenson, Greenville, SC (US)

(72) Inventor: Allen Daniel Stephenson, Greenville, SC (US)

(21) Appl. No.: 15/599,065

(22) Filed: May 18, 2017

Related U.S. Application Data
(60) Provisional application No. 62/458,342, filed on Feb. 13, 2017.

(51) Int. Cl. G01B 5/24

(52) U.S. Cl. CPC G01B 5/24

(57) ABSTRACT

An alignment aid that includes first, second, and third references aligned along a first axis. Each reference has a length parallel to the first axis and a width orthogonal to the first axis. A distance between adjacent references increases along the first axis. In particular embodiments, the length and/or width of each reference may increase along the first axis. Other particular embodiments may include parallel lines aligned parallel along the first axis and/or a contrast on each side of each reference.

### CROSS REFERENCE TO RELATED APPLICATIONS

The present application claims priority to U.S. Provisional Application Ser. No. 62/458,342, filed on Feb. 13, 2017 and which is incorporated by reference herein in its entirety.

### FIELD OF THE INVENTION

The present invention generally involves an alignment aid that may be used to aim an object at a desired target.

### BACKGROUND OF THE INVENTION

Many tools and other objects require an operator to position or aim the tool in a desired direction or at a desired target during use. For example, an operator must point and aim a pointer, laser, bow and arrow, hand gun, shot gun, rifle, or other weapon at a desired target during use. The particular direction of aim depends solely on the relative location of the target with respect to the operator and may generally be described as the line of sight between the operator and the target. For example, the operator looks at the target and then positions or aims the tool or object to point along the operator's line of sight to the target.

In many cases, the tool or object includes an alignment aid that assists the operator to quickly and accurately aim the tool or object. For example, weapons often include a set of front and rear sights that allow the operator to aim the weapon at the target by visually lining up the front and rear sights along the line of sight to the target. Although front and rear sights provide a geometrically accurate solution for aligning the weapon to the target along the line of sight, the sights also necessarily require the operator to place the weapon directly in the operator's line of sight to the target which may undesirably obscure the operator's view of the target. In addition, the physical task of visually lining up the target with the front and rear sights takes time and coordination that may not exist during a crisis that requires immediate response to a moving or stationary target. Moreover, the front and rear sights generally protrude from the weapon, creating snag points that reduce the mobility of the weapon and which may require periodic alignment to confirm they are proper aligned.

Therefore, the need exists for an improved alignment aid that may be temporarily or permanently fixed to a tool or object to facilitate efficient and accurate aiming of the tool or object at a desired target.

### BRIEF DESCRIPTION OF THE INVENTION

Aspects and advantages of the invention are set forth below in the following description, or may be obvious from the description, or may be learned through practice of the invention.

One embodiment of the present invention is an alignment aid that includes first, second, and third references aligned along a first axis. Each reference has a length parallel to the first axis and a width orthogonal to the first axis. A distance between adjacent references increases along the first axis. In particular embodiments, the length and/or width of each reference may increase along the first axis. Other particular embodiments may include parallel lines aligned parallel along the first axis and/or a contrast on each side of each reference.

An alternate embodiment of the present invention is an alignment aid that includes first, second, and third references aligned along a first axis, wherein each reference has a length parallel to the first axis and a width orthogonal to the first axis. The length of each reference increases along the first axis. In particular embodiments, a distance between adjacent references may progressively increase along the first axis and/or the width of each reference may increase along the first axis.

In yet another embodiment of the present invention, an alignment aid includes first, second, and third references aligned along a first axis, wherein each reference has a length parallel to the first axis and a width orthogonal to the first axis. The width of each reference increases along the first axis.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a top plan view of an embodiment of the present invention installed on the top surface of a hand gun;

FIG. 2 is a top plan view of the embodiment shown in FIG. 1 installed on the top surface of a different-sized hand gun;

FIG. 3 is a top plan view of the embodiment shown in FIG. 1;

FIG. 4 is a top plan view of a second embodiment of the present invention;

FIG. 5 is a top plan view of a third embodiment of the present invention;

FIG. 6 is a top plan view of a fourth embodiment of the present invention;

FIG. 7 is a top plan view of a fifth embodiment of the present invention;

FIGS. 8A-8E are top plan views of additional exemplary embodiments of the present invention; and

FIG. 9 is a top plan view of a sixth embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. As used herein, the phrase “vanishing property of perspective” refers to the optical illusion in which evenly spaced, identical objects appear narrower and closer together as the distance from a viewer increases. For example, a conventional railroad track includes evenly spaced, identical width railroad ties that extend between parallel rails. When looking along a long length of railroad track, the width of the ties, the distance between adjacent ties, and the distance between the parallel rails each appears to decrease as the distance from the viewer increases, ultimately converging to a vanishing point.

Embodiments of the present invention offset or reverse the vanishing property of perspective to provide an alignment aid 10 that may be used to aim an object 12 at a desired target. The alignment aid 10 may be a template, a plate, or any other suitable material that may be temporarily or permanently attached to the object 12. Alternately, the alignment aid 10 may be integrally incorporated into the manufacture of the object 12 itself, such as through molding, forging, casting, etching, or other suitable manufacturing techniques. For illustrative purposes, embodiments of the present invention will be illustrated in the context of an alignment aid 10 for a hand gun 12, shot gun, or rifle. However, the present invention is not limited to any particular object unless recited in the claims, and embodiments of the present invention may be suitably adapted for use with a pointer, laser, bow and arrow, or virtually any object that would benefit from faster, easier, and/or more accurate alignment with a desired target.

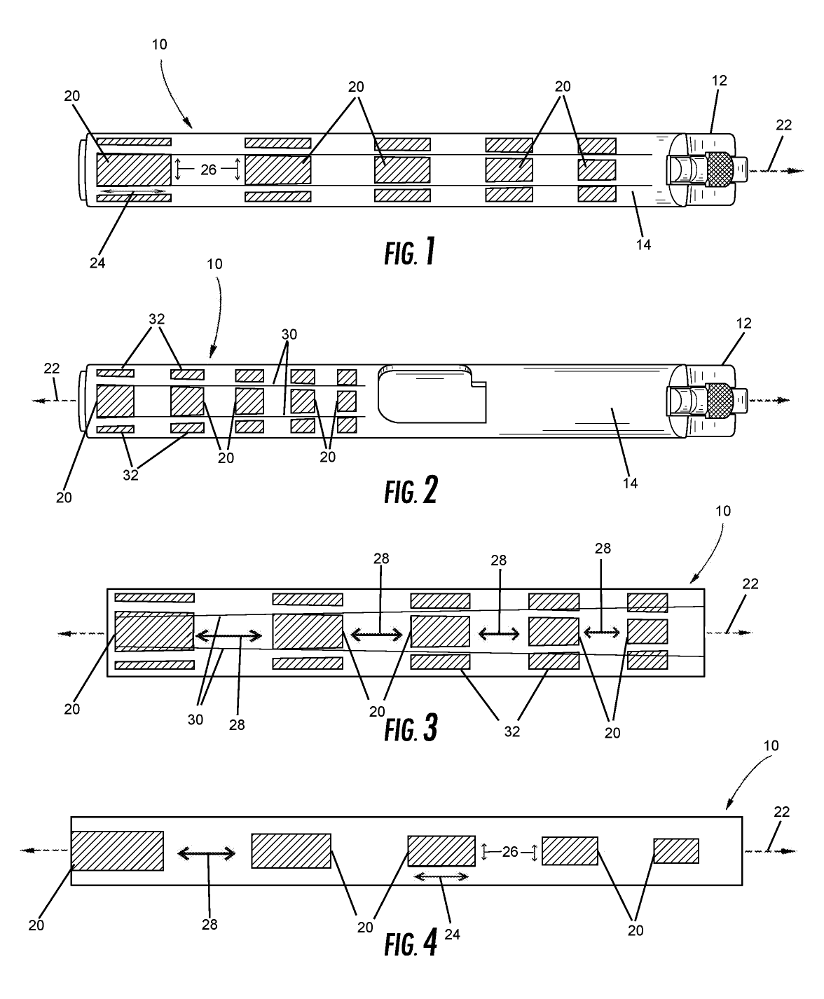

FIGS. 1 and 2 provide top plan views of an alignment aid 10 according to one embodiment of the present invention installed on a hand gun 12, and FIG. 3 provides a top plan view of the alignment aid 10 shown in FIG. 1 without the hand gun 12. As shown in FIGS. 1 and 2, the alignment aid 10 is sized to fit on a top surface 14 of the object 12 so the alignment aid 10 is easily visible to the operator during use of the object 12. As shown in FIGS. 1-3, the alignment aid 10 generally includes a plurality of references 20 aligned along an axis 22 of the object 12. The number of references 20 will vary according to the particular dimensions of the object 12. For example, smaller objects 12 with limited surface area on the top surface 14 may only accommodate two or three references 20 aligned along the axis 22. Larger objects, such as a shot gun or rifle with substantially larger surface area on the top surface 14 may readily accommodate 5, 10, or more references 20 aligned along the axis 22.

Each reference 20 may be any shape or outline of any shape, and individual references 20 may include multiple shapes or outlines of multiple shapes. For example, a reference 20 may be one or more dots, lines, circles, polygons, designs, or any other symbols spaced along the axis 22 that define a length 24 parallel to the axis 22 and a width 26 orthogonal to the axis 22. The length 24, width 26, and/or spacing 28 between adjacent references 20 may increase along the axis 22 to offset or reverse the vanishing property of perspective to provide an operator with a natural perspective or quick reference to ensure that the object 12 is aligned with the line of sight to the intended target. For example, in the particular embodiment shown in FIGS. 1-3, the references 20 are rectangles that progressively increase in length 24, width 26, and spacing 28 from right to left. The increase in length 24, width 26, and spacing 28 between adjacent references 20 may be between 10% and 40% or more, depending on the size and length of the alignment aid 10. For example, adjacent references 20 may have an increase in length 24, width 26, and/or spacing of 20% compared to the next adjacent references 20. However, particular embodiments are not limited to any specific increase in length 24, width 26, or spacing 28 unless specifically recited in the claims.

The references 20 may be painted or colored to enhance visibility of the references 20 without creating any snag points that would interfere with smooth storage and retrieval of the object 12. Alternately or in addition, the references 20 may be raised shapes that project upward from the top surface 14 of the object 32 to similarly enhance visibility of the references 20 without unduly restricting mobility. As shown in FIGS. 1-3, in still further embodiments, the alignment aid 10 may further include parallel lines 30 and/or other contrasts 32 of varying width that extend along the axis on either side of the references 20 to accentuate the visibility of the references 20. The parallel lines 30 and/or contrasts 32 may be a contrasting color to the references 20, and as best seen in FIG. 3, their location on either side of the references 20 accentuates the increasing width 26 of the references 20 from right to left along the axis 22 when viewed from above.

The increased length 24, width 26, and spacing 28 between adjacent references 20 from right to left is more readily apparent when viewed from directly above, as shown in FIGS. 1-3. In use, however, the operator would look at the desired target and extend the object 12 away from the operator and toward the target at an elevation slightly below the line of sight from the operator to the target. In this position, the alignment aid 10 is between the operator and the target and slightly below the line of sight between the operator and the target. As a result, the operator is able to directly view the target while also being able to peripherally view the alignment aid 10 from the right end of the axis 22 as shown in FIGS. 1-3. From this axial perspective of the alignment aid 10, the operator may conveniently and reliably determine if the object 12 is accurately pointed at the target. For example, if the object 12 is aimed too low, then the alignment aid 10 will be angled away from the operator, and the operator will not be able to see much or any of the alignment aid 10. Conversely, if the object 12 is aimed too high, then the references 20 closer to the operator will appear narrower and closer together than the references 20 further from the operator, similar to what is shown in FIG. 3. If the object 12 is properly aimed along the line of sight to the target, then all of the references 20, directly or peripherally seen by the operator, will appear to have the same width 26 and spacing 28 due to the vanishing property of perspective optical illusion. In this manner, the alignment aid 10 provides the operator with a convenient and reliable aid to quickly and accurately aim the object 12 at the target.

FIG. 4 provides a top plan view of the alignment aid 10 according to a second embodiment of the present invention. In this embodiment, the alignment aid 10 again includes the plurality of references 20 aligned along the axis 22 as previously described with respect to FIGS. 1-3. That is, the references 20 are rectangles that progressively increase in length 24, width 26, and spacing 28 from right to left. In this embodiment, however, the alignment aid 10 does not include parallel lines 30 or contrasts 32. For some applications, it is anticipated that this cleaner, less cluttered appearance of the references 20 will enable the operator to more easily determine when the object 12 is properly aimed at the target.

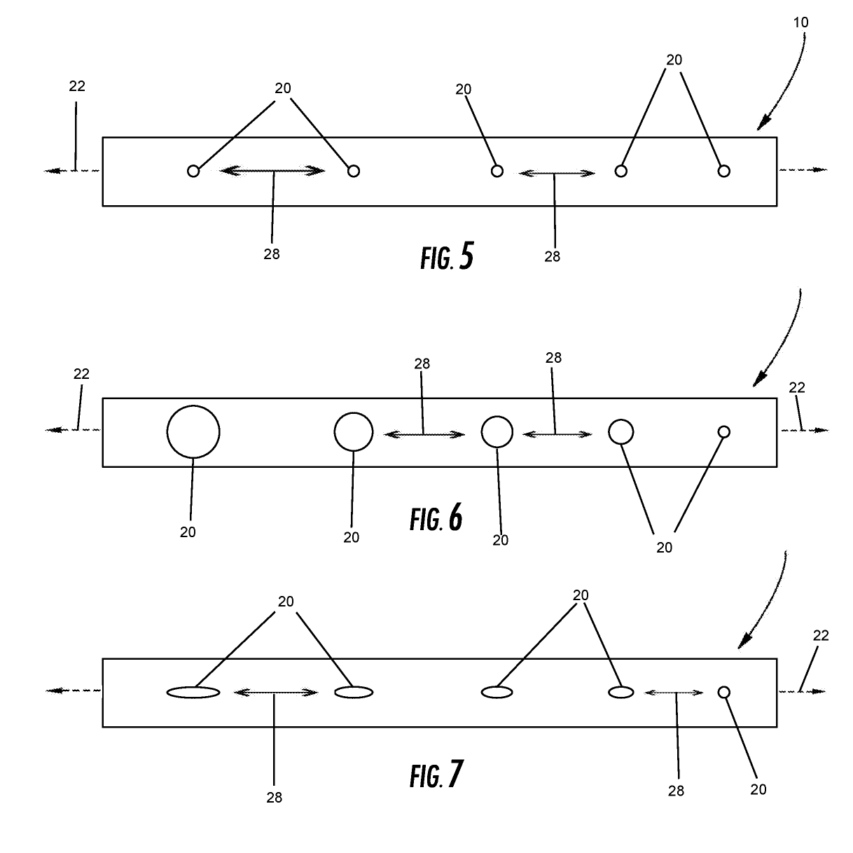

FIGS. 5-7 provide top plan views of the alignment aid 10 according to alternate embodiments of the present invention to illustrate that various combinations of varying length 24, width 26, and spacing 28 may be used to offset the vanishing property of perspective. As shown in FIG. 5, the references 20 are identically sized circles, and the spacing 28 between adjacent references 20 progressively increases from right to left. In this manner, when viewed axially from the right, the references 20 will appear evenly spaced when the object 12 is correctly aimed at the target along the line of sight. In FIG. 6, the references 10 are circles that progressively increase in size from right to left with the same spacing 28 between adjacent references 20. In this manner, when viewed axially from the right, the references 20 will appear to have the same width 26 when the object 12 is correctly aimed at the target along the line of sight. In FIG. 7, the references 10 have a constant width 26 and progressively increase in length 24 and spacing between adjacent references 20 from right to left. In this manner, when viewed axially from the right, the references 20 will appear evenly spaced when the object 12 is correctly aimed at the target along the line of sight.

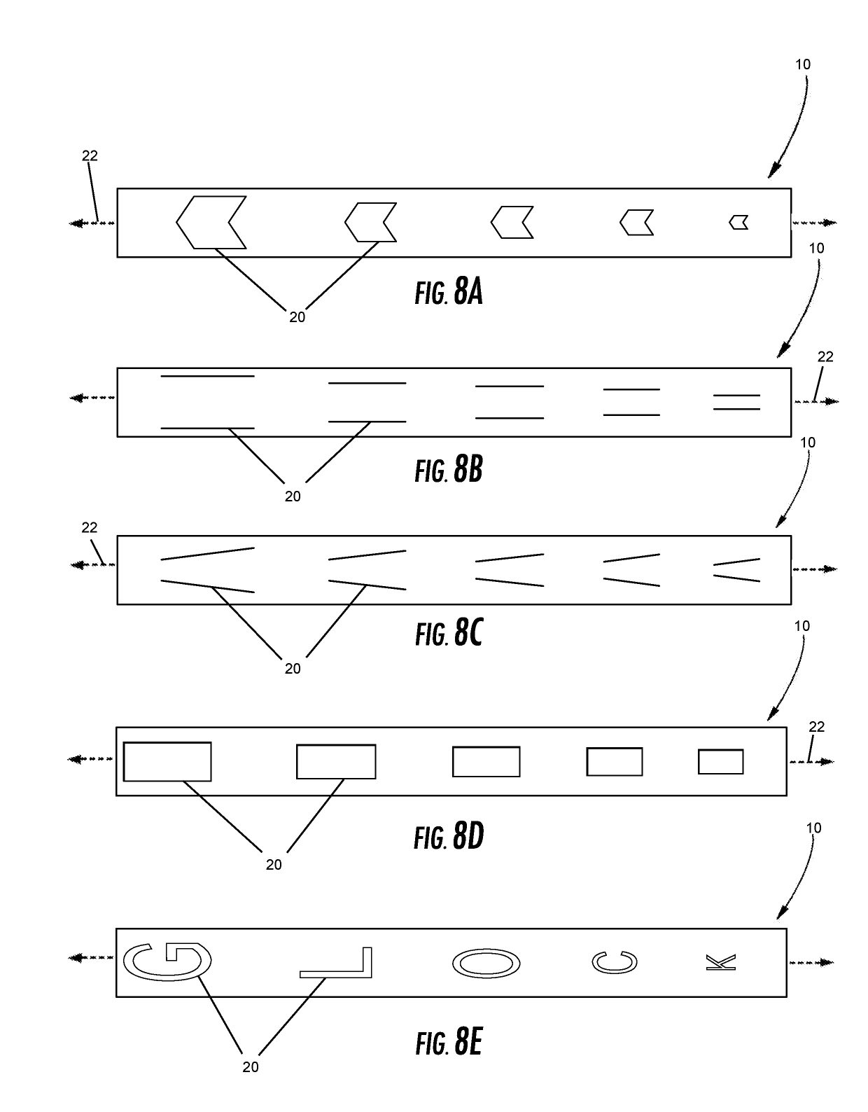

FIGS. 8A-8E provide top plan views of additional exemplary embodiments of the present invention to illustrate additional sizes and shapes for the references 20 within the scope of the present invention. In each embodiment shown in FIGS. 8A-8E, the references 20 progressively increase in length 24, width 26, and spacing 28 from right to left. As shown in FIG. 8A, the references 20 may be polygons having the shape of a chevron. In FIG. 8B, each reference 20 is a pair of parallel lines. In FIG. 8C, each reference is a pair of canted lines. In FIG. 8D, each reference 20 is an outline or perimeter of a rectangle, as opposed to the solid rectangles previously described and illustrated in FIGS. 1-4. In FIG. 8E, the references 20 are the letters of a logo, brand, or trademark. These embodiments demonstrate that the references 20 may have many different shapes, and particular embodiments of the present invention are not limited to any particular shape unless recited in the claims.

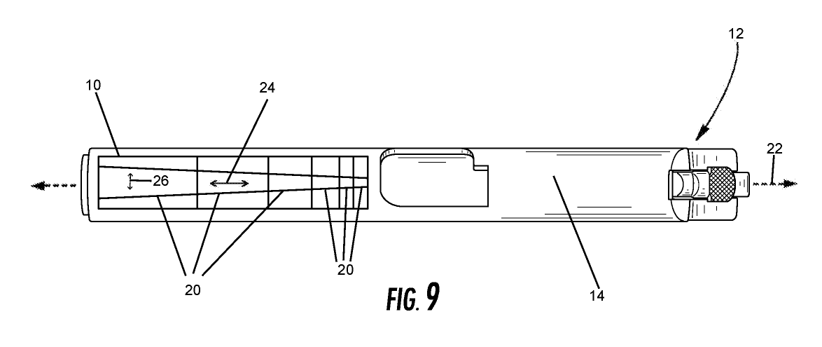

FIG. 9 provides a top plan view of the alignment aid 10 according to another embodiment of the present invention. As shown in FIG. 9, each reference 20 is a trapezoid, and the length 24 and width 26 of the references 20 progressively increase from right to left along the axis 22 with little or no spacing between adjacent references 20. As with other embodiments, when viewed axially from the right, the references 20 will appear to have the same width 26 when the object 12 is correctly aimed at the target along the line of sight.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An alignment aid, comprising:
first, second, and third references aligned along a first axis, wherein each reference has a length parallel to said first axis and a width orthogonal to said first axis, and
wherein a distance between adjacent references increases along said first axis.

2. The alignment aid as in claim 1, wherein said distance between adjacent references progressively increases along said first axis.

3. The alignment aid as in claim 1, wherein said length of each reference increases along said first axis.

4. The alignment aid as in claim 1, wherein said length of each reference progressively increases along said first axis.

5. The alignment aid as in claim 1, wherein said width of each reference increases along said first axis.

6. The alignment aid as in claim 1, wherein said width of each reference progressively increases along said first axis.

7. The alignment aid as in claim 1, further comprising parallel lines aligned parallel along said first axis.

8. The alignment aid as in claim 1, further comprising a contrast on each side of each reference.

9. An alignment aid, comprising:
first, second, and third references aligned along a first axis, wherein each reference has a length parallel to said first axis and a width orthogonal to said first axis, and
wherein said length of each reference increases along said first axis.

10. The alignment aid as in claim 9, wherein said length of each reference progressively increases along said first axis.

11. The alignment aid as in claim 9, wherein a distance between adjacent references progressively increases along said first axis.

12. The alignment aid as in claim 9, wherein said width of each reference increases along said first axis.

13. The alignment aid as in claim 9, wherein said width of each reference progressively increases along said first axis.

14. The alignment aid as in claim 9, further comprising parallel lines aligned parallel along said first axis.

15. The alignment aid as in claim 9, further comprising a contrast on each side of each reference.

16. An alignment aid, comprising:
first, second, and third references aligned along a first axis, wherein each reference has a length parallel to said first axis and a width orthogonal to said first axis, and
wherein said width of each reference increases along said first axis.

17. The alignment aid as in claim 16, wherein said width of each reference progressively increases along said first axis.

18. The alignment aid as in claim 16, wherein a distance between adjacent references progressively increases along said first axis.

19. The alignment aid as in claim 16, wherein said length of each reference progressively increases along said first axis.

20. The alignment aid as in claim 16, further comprising parallel lines aligned parallel along said first axis.
